(19) United States
(12) Patent Application Publication
(10) Pub. No.: US 2009/0223250 A1
(43) Pub. Date: Sep. 10, 2009

(54) MANUFACTURING METHOD OF POLARIZING GLASS AND POLARIZING GLASS ARTICLE

(75) Inventors: Masahiro Ichimura, Niigata (JP); Yuichi Aoki, Niigata (JP)

Correspondence Address: OSHA LIANG L.L.P., TWO HOUSTON CENTER, 909 FANNIN, SUITE 3500, HOUSTON, TX, 77010, US

(73) Assignee: ARISAWA MFG. CO., LTD., Joetsu-shi (JP)

(21) Appl. No.: 11/955,126

(22) Filed: Dec. 12, 2007

Related U.S. Application Data
(62) Division of application No. 11/320,534, filed on Dec. 28, 2005, now abandoned.
(60) Provisional application No. 60/673,269, filed on Apr. 20, 2005.

(51) Int. Cl. C03C 10/16; C03B 17/06

(52) U.S. Cl. 65/33.3; 65/91

(57) ABSTRACT

There is provided polarizing glass having a high extinction ratio in a broad band. A manufacturing method of the polarizing glass containing elongated metal particles dispersed and oriented within glass includes an elongation step of forming mother glass after heat-treatment into a preform, of heating the preform at such temperature that the viscosity of the glass becomes about 1×10⁸ to 1×10¹⁴ poise, of applying stress of about 200 kg/cm² to 500 kg/cm² to the preform while moving the preform within an electric furnace with feeding speed of 10 mm/min. or less and of elongating the preform as an elongated sheet with pulling speed of 150 mm/min. or less by which an aspect ratio of halogenated metal particles contained in the preform becomes from 2 to 1 to 100 to 1 and a reduction step of reducing the elongated sheet for enough time for transforming at least a part of the halogenated metal particles into metal particles at temperature higher than the strain point temperature of the mother glass and lower than the transition point temperature of the mother glass.

### CROSS REFERENCE TO RELATED APPLICATION

The present application claims priority from a U.S. Provisional Application No. 60/673,269 filed on Apr. 20, 2005, the contents of which are incorporated herein by reference.

### BACKGROUND OF THE INVENTION

1. Field of the Invention

The present invention relates to a manufacturing method of polarizing glass and polarizing glass articles. More specifically, the invention relates to a manufacturing method of polarizing glass and polarizing glass articles having a high extinction ratio in a broad band.

2. Related Art

With the progress of practical use of a blue semiconductor laser, polarizing glass is expected to be used as a polarizing element used in a high-density recording apparatus, an LCD projector and the like in a visible region of 400 nm to 700 nm. It is also used as optical parts used particularly in a polarized wave-dependent optical isolator for the use of optical communications in a near infrared region.

Accordingly, it is required to have high performance and to be low cost, though it actually has difficult problems. For example, U.S. Pat. No. 6,221,480 and JP2001-505671 disclose polarizing glass, and its manufacturing method, whose band presenting an extinction ratio of at least 50 dB is at least 300 nm.

U.S. Pat. No. 6,761,045 and JP2003-517634 also disclose polarizing glass, and its manufacturing method, whose band presenting an extinction ratio of at least 50 dB is 660 nm.

Meanwhile, JP3105491 discloses a method of elongating a line by using preform wherein at least two surfaces thereof facing to each other have been polished.

JP3320044 also discloses a method of elongating a line by using preform whose surface has been etched by acid aqueous solution.

While the methods shown in the foregoing publications Patent Documents 1 through 4 disclose the method of widening the band presenting the extinction ratio of at least 50 dB, it mainly owes to the improvement of a hydrogen reducing process which is characterizing in that ambient pressure during reduction is increased (10 atmospheric pressure or more) or the reduction time is prolonged (12 hours or more).

Accordingly, there has been a problem that it is difficult to lower the cost because a hydrogen reducing apparatus has an explosion-proof structure from the reason of safety and it takes a long time for the operation.

Still more, while the methods disclosed in the latter two conventional arts Patent Documents 5 and 6 are carried out mainly for the purpose of preventing the preform from rupturing during elongation, the machining cost increases inevitably due to the polishing or etching. Still more, etching in particular has been the cause of high cost of the polarizing glass because it requires an operation and processing facility, an etching waste disposal facility and high processing cost.

There has been also a problem that stress applied to the preform during elongation cannot but be set as low as below 300 Kg/cm² in order to avoid the rupture of the preform.

Then, the inventors of the invention have discovered that high-quality polarizing glass may be manufactured at low cost by simply improving a manufacturing apparatus and a manufacturing method.

Here, the inventors have noticed on an extinction ratio of 60 dB due to the following reasons.

Two sheets of polarizing glass used for an optical isolator are disposed accurately at an angle of 45° from each other in order to achieve the function of isolator. If this disposition is inaccurate, an extinction ratio of the isolator drops, causing a problem that the isolator cannot block light returning to a laser diode (LD) and oscillation of the LD is destabilized.

The extinction ratio in the polarizing glass may be obtained from the fact that a spectral absorption coefficient differs due to the anisotropy of shape of elongated metal particles (length and breadth), presenting a very large dichroism.

Here, an axis of the length will be called as a polarizing axis. The accurate disposition described above means to make the axes of length, i.e., the polarizing axes, coincident with each other between two sheets of polarizing glass at an angular difference of 45°. Thereby, a high-performance optical isolator may be manufactured.

However, if an inclination of the polarizing axis is large within a surface of the polarizing glass, the two sheets of polarizing glass may not be disposed accurately with the positional relationship of 45°. That is, even if the polarizing axes coincide accurately at the angle of 45° within a certain surface, the polarizing axis inclines within another surface, so that the sheets of polarizing glass are disposed at an angle smaller or larger than 45°.

Then, the extinction ratio drops as a result. Accordingly, it is preferable to have the extinction ratio of at least 60 dB per one sheet, considering the inclination of the polarizing axis, in order to obtain the extinction ratio of 50 dB or more within the surface of the polarizing glass.

### SUMMARY OF THE INVENTION

According to a first aspect of the invention, there is provided a manufacturing method of polarizing glass containing elongated metal particles dispersed and oriented within glass, having a melting step of melting mother glass containing metal and halogen, a precipitation step of precipitating halogenated metal particles by heat-treating the mother glass, an elongation step of forming the mother glass after heat-treatment into a preform, of heating the preform at such temperature that the viscosity of the glass becomes about 1×10⁸ to 1×10¹⁴ poise, of applying stress of about 200 kg/cm² to 700 kg/cm² to the preform while moving the preform within an electric furnace with feeding speed of 10 mm/min. or less and of elongating the preform as an elongated sheet with pulling speed of 150 mm/min. or less by which an aspect ratio of the halogenated metal particles contained in the preform becomes from 2 to 1 to 100 to 1 and a reduction step of reducing the elongated sheet for enough time for transforming at least a part of the halogenated metal particles into metal particles at temperature higher than the strain point temperature of the mother glass and lower than the transition point temperature of the mother glass.

In the manufacturing method described above, the precipitation step may include a heat-treatment process for heating the mother glass to generate crystal nuclei for at least one hour at temperature higher than the transition point temperature and lower than the softening point temperature and then to grow the crystal nuclei for at least two hours at temperature higher than the softening point temperature and not higher than the softening point temperature by 70° C. to precipitate the halogenated metal particles.

In the precipitation step, a haze (cloudiness) caused by the precipitation of crystal of the precipitated halogenated metal particles may be set at 2% to 30%.

In the elongation step of the manufacturing method described above, the ratio of speed for feeding the preform to speed for pulling the elongated sheet may be 15 or more.

In the elongation step in the manufacturing method described above, the stress applied to the preform may be 350 kg/cm² or more.

In the elongation step in the manufacturing method described above, the front and back surfaces of the preform and both ends thereof in the longitudinal direction may be heated.

In the manufacturing method described above, the composition of the mother glass may be, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O:B₂O₃ may be about 0.55 to 0.85 and the weight ratio of Ag:(Cl+Br) may be about 0.40 to 0.95.

Still more, the mother glass may contain, as the other components, less than 10% of composition selected from components including ZrO₂ by 0.6% or less, TiO₂ by 3% or less, PbO by 0.5% or less, BaO by 7% or less, CaO by 4% or less, MgO by 3% or less, Nb₂O₅ by 6% or less, La₂O₃ by 4% or less and F by 2% or less. The weight ratio of Ag:(Cl+Br) may be 0.60 or less.

According to a second aspect of the invention, there is provided a polarizing glass article manufactured by the manufacturing method described above wherein a band presenting an extinction ratio of 60 dB or more is 250 nm or more in a wavelength range of 900 nm to 1900 nm. Preferably, the polarizing glass article described above is what the band presenting the extinction ratio of 70 dB or more is 250 nm or more in the wavelength range of 900 nm to 1900 nm.

It is noted that the summary of the invention described above does not necessarily describe all necessary features of the invention. The invention may also be a sub-combination of the features described above.

As it is apparent from the above description, according to the invention, the polarizing glass presenting the extinction ratio of 70 dB or more in the band of 250 nm or more may be manufactured at low cost without special improvement or processing in the hydrogen reduction step or in the formation of preform because the elongation is carried out by relatively retarding the feeding and pulling speeds in the elongation step. Still more, the quantity and grain size of the halogenated metal particles may be controlled to the predetermined values by once generating the crystal nucleus of the halogenated metal particles and by then growing the crystal nucleus, not generating and growing the crystal nucleus concurrently, in the inventive precipitation step.

Furthermore, the preform may be elongated without rupture even if the preform having bad surface condition is used and even if stress of 400 kg/cm² or more is applied by elongating the preform while heating the front and back surfaces and the both ends in the width direction thereof and relatively retarding the speeds for feeding and pulling the preform.

Then, because the ratio of the preform feeding speed to the pulling speed is high, in addition to such high stress and because sudden stress is apt to be applied in microscale to the halogenated metal particles and the relatively small particles are also apt to be elongated, the halogenated metal particles may have various aspect ratios.

### BRIEF DESCRIPTION OF THE DRAWINGS

FIG. 1 shows a configuration of an elongating apparatus.

FIG. 2 is a conceptual drawing showing a state in which halogenated metal particles are elongated.

### DETAILED DESCRIPTION OF THE INVENTION

The invention will now be described based on preferred embodiments, which do not intend to limit the scope of the invention, but exemplify the invention. All of the features and the combinations thereof described in the embodiments are not necessarily essential to the invention.

A manufacturing method of polarizing glass of the present embodiment has a melting step of melting mother glass containing metal and halogen, a precipitation step of precipitating halogenated metal particles by heat-treating the mother glass, an elongation step of elongating preform, i.e., the mother glass after the heat treatment, as a sheet to be elongated and a reduction step of reducing for enough time for transforming at least a part of the halogenated metal particles into metal particles.

In the melting step of the present embodiment, AgCl and AgBr are used as silver and halide with the silver. While the mother glass may be selected from photochromic glass composition disclosed in U.S. Pat. No. 4,190,451, the ratio of silver and halide by weight which is a factor presenting the photochromic characteristics is preferable to be Ag:(Cl+Br)=0.60 or less because thereby the extinction ratio is apt to become high and the band is apt to become broad. It is noted that CuCl may be used as the metal halide.

The precipitation step has two processes of a nucleus generating process for generating a crystal nucleus and a grain growing process of growing the crystal nucleus. Nucleus generating speed differs from grain growth speed depending on the treatment temperature. Accordingly, the heat treatment for generating the nucleus is carried out for at least one hour at temperature by which the nucleus generating speed becomes relatively fast in a temperature range higher than the transition point temperature of the glass and lower than the softening point temperature. Meanwhile, the heat treatment for growing the grain is carried out at least for two hours at temperature by which the grain growth speed becomes relatively fast in a temperature range higher than the softening point temperature of glass and not higher than the softening point temperature by 70° C. The longer the nucleus generating time, the more a number of the crystal nuclei increases and higher the grain growth temperature and longer its time, the larger the grain size becomes.

Halogenated metal particles precipitated by this heat treatment are AgCl and AgBr. The grain size of the precipitated particles is 20 nm to 200 nm, though it is preferable to be 100 nm or less.

Here, as a value for indirectly knowing the grain size and quantity of the precipitated particles, a haze (cloudiness) is used and the heat treatment is carried out so that the haze of the glass of 2 mm thick becomes 2% to 30%. While the haze depends on the quantity and grain size of the halogenated metal particles, it is not understood yet that which of them affects the haze more. However, the haze was thought to be affected more by the grain size when the haze was checked under various heat-treatment conditions as shown in Table 1. That is, when the haze is low, the grain size of the halogenated metal particles contained in the mother glass is considered to be small. When the inventor et. al. processed glass having such various hazes into polarizing glass by using a method described later, the inventor found that the polarizing glass is apt to have a high extinction ratio and a broad band when the haze is preferably 5% to 20% or more preferably around 10%.

TABLE 1

| Sample No. | 1 | 2 | 3 | 4 | 5 | 6 | 7 | 8 |
|---|---|---|---|---|---|---|---|---|
| Nucleus | 580 | 580 | 580 | 600 | 600 | 600 | 620 | 620 |
| Generating | deg. | deg. | deg. | deg. | deg. | deg. | deg. | deg. |
| Condition | 2 | 2 | 4 | 2 | 2 | 4 | 2 | 2 |
| | hrs | hrs | hrs | hrs | hrs | hrs | hrs | hrs |
| Grain | 700 | 720 | 700 | 700 | 720 | 700 | 700 | 720 |
| Growing | deg. | deg. | deg. | deg. | deg. | deg. | deg. | deg. |
| Condition | 4 | 4 | 4 | 4 | 4 | 4 | 4 | 4 |
| | hrs | hrs | hrs | hrs | hrs | hrs | hrs | hrs |
| Haze (%) | 13.0 | 26.1 | 13.2 | 13.4 | 30.1 | 13.5 | 13.7 | 30.7 |

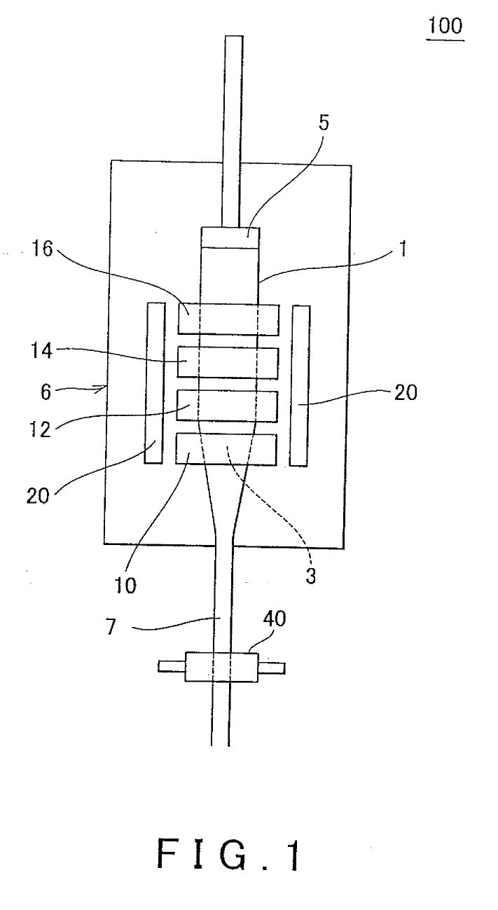

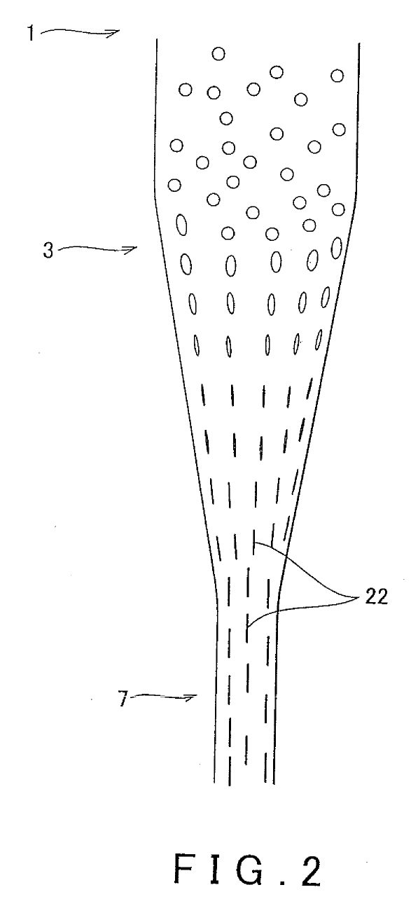

FIG. 1 shows a configuration of an elongating apparatus 100 for carrying out the elongation step of the present embodiment. FIG. 2 is a conceptual drawing showing a state in which the halogenated metal particles 22 are elongated. The elongating apparatus 100 has an electric furnace 6, a glass supporter 5 provided within the electric furnace 6, various heaters 10, 12, 14, 16 and 20 provided also within the electric furnace 6 and elongating means 40 provided under the various heaters described above in terms of a longitudinal direction of the preform 1.

In the elongation step, the preform 1 is fixed by the glass supporter 5 and is elongated by the pulling means 40 in the longitudinal direction while being heated by the various heaters disposed around the preform 1. In the present embodiment, one longitudinal end of the preform 1 is elongated downward by the pulling means 40 provided below the heaters while slowly moving downward the glass supporter 5 that fixes the other end of the preform 1 formed into the shape of a strip.

The present embodiment will be explained below by using the positional relationship shown in FIG. 1. It is noted that the direction into which the preform 1 is elongated is not limited to be downward. For example, the preform 1 may be elongated upward by the pulling means 40 provided above the heaters while fixing the lower end of the preform 1 by the glass supporter 5.

The preform 1 is heated by the various heaters 10, 12, 14, 16 and 20 provided around the preform 1. The heaters include the main heater 10 that heats around the center in a width direction of an elongated portion 3 where contraction of the preform 1 in the width direction occurs from the front of the strip in the elongated portion 3, the side heaters 20 that heat the side surfaces of the elongated portion 3 from the sides of the strip in the elongated portion 3, the sub-heaters 12, 14 and 16 disposed above the main heater 10 at predetermined intervals.

The main heater 10 and the sub-heaters 12, 14 and 16 have a width slightly wider than the preform 1. Output of the plurality of heaters 10, 12, 14, 16 and 20 is controlled independently from each other. Thereby, the preform 1 is heated at temperature distribution suitable for elongation. That is, heating is carried out at the temperature distribution that allows the preform 1 to be elongated favorably and allows the halogenated metal particles to be elongated favorably by elongating the preform 1. The sub-heaters 12, 14 and 16 heat the upper part of the elongated portion 3 stepwise.

In the elongation step, the preform 1 is put into the electric furnace 6 and stress of 200 kg/cm² to 700 kg/cm² is applied thereto while heating by the main heater 10 and the sub-heaters 12, 14, 16 and 20 at temperature by which the viscosity of the glass becomes from 1×10⁸ poise to 1×10¹⁴ poise to elongate and form the elongated sheet 7 so that the aspect ratio of the halogenated metal particle (AgCl, AgBr) becomes from 2 to 1 to 100 to 1. At this time, the viscosity of the glass is preferable to be 1×10¹⁰ poise to 1×10¹² poise. It is preferable to be able to elongate the preform 1 without rupture even if high stress of 350 kg/cm² or more is applied thereto in this case. Still more, although the extinction ratio is apt to be high and the band to be broad when the mother glass whose haze is relatively low, i.e., the grain size of the halogenated metal particles contained therein is small, is processed as the polarizing glass as described above, it is also preferable to elongate it with high stress in this case. For example, it is preferable to elongate with stress of about 700 Kg/cm² in obtaining high extinction ratio in a near infrared region (1550 nm) by using glass whose haze is 7% for example.

Speed (feeding speed) for moving the preform 1 within the electric furnace 6 is set at 10 mm/min. or less and speed (pulling speed) for elongating the preform 1 to form the elongated sheet 7 is set at 150 mm/min. or less. The preform 1 hardly cracks or ruptures by elongating the elongated sheet 7 slowly while moving the preform 1 slowly within the electric furnace 6. Such feeding and pulling speeds allow the preform 1 to be elongated without rupture even when the preform 1 has a surface condition ground or lapped at low cost instead of polishing the front and back surfaces of the preform 1.

Still more, if the ratio (Vp/Vf) of the feeding speed (Vf) to the pulling speed (Vp) is 15 or more, the halogenated metal particles 22 within the elongated sheet 7 are apt to extend in various aspect ratios and the extinction ratio is apt to be high and the band to be broad. It is assumed that the halogenated metal particles 22 are apt to extend in the various aspect ratios because instantaneous load applied to the preform 1 becomes high. No such a phenomenon that the halogenated metal particles 22 once elongated are re-globulized during the time coming out of the electric furnace 6 is confirmed in the present embodiment even if the elongation is slowly carried out.

Because strain is left in the elongated sheet 7 elongated by the elongation step described above, annealing is carried out at temperature above the strain point temperature and below the transition point temperature of the glass. It is not preferable to anneal at temperature higher than the transition point temperature, e.g., at the annealing point temperature, because the elongated halogenated metal particles 22 are possibly re-globulized.

The reduction step is carried out in a hydrogen gas atmosphere. The higher the reduction temperature is, the deeper the hydrogen diffuses within the glass and hence the processing time may be shortened. However, the problem that the elongated halogenated metal particles are re-globulized occurs if the temperature is higher than the transition point temperature similarly to the case of annealing of the elongated sheet 7. Low reduction temperature is not also economical because it takes 10 hours or more for the processing time. Accordingly, the reduction is carried out at temperature higher than the strain point temperature and lower than the transition point temperature of the glass.

According to the present embodiment, the preform 1 is elongated by relatively slowing down the feeding speed of the glass supporter 5 and the pulling speed of the pulling means 40 in the elongation step, so that the polarizing glass presenting the extinction ratio of 70 dB or more in the band of 250 nm or more may be manufactured at low cost without requiring special improvement or processing in the hydrogen reducing step and in the formation of the preform.

Still more, because the crystal nucleus is grown after generating the crystal nucleus once, not generating and growing the crystal nucleus of the halogenated metal particle 22 concurrently, the quantity and grain size of the halogenated metal particles 22 may be controlled at predetermined values.

Further, because the preform 1 is elongated by relatively slowing down the feeding and pulling speed while heating the front and back surfaces and the both end surfaces in the width direction of the preform 1 by the main heater 10 and the sub-heaters 12, 14, 16 and 20 in the elongation step, the preform 1 may be elongated without rupture even if the preform 1 having a bad surface condition is used and even if stress of 400 kg/cm² or more is applied.

Still more, because the ratio of the feeding speed to the pulling speed of the preform 1 is high, abrupt stress is apt to be applied in microscale to the halogenated metal particles 22, in addition to such high stress, and even relatively small particles are apt to be elongated. Accordingly, the halogenated metal particles 22 may have the various aspect ratios.

### First Embodiment

Material of glass containing Li₂O by 1.8 wt %, Na₂O by 4.1 wt %, K₂O by 5.7 wt %, B₂O₃ by 18.1 wt %, Al₂O₃ by 6.2 wt %, SiO₂ by 56.3 wt %, Ag by 0.22 wt %, Cl by 0.22 wt %, Br by 0.18 wt %, CuO by 0.006 wt %, ZrO₂ by 5.0 wt % and TiO₂ by 2.3 wt % was put into a platinum pot furnace to carry out pre-melting at about 1,350° C. The glass obtained by the pre-melting was crashed into the size of candy as cullets which were then put into the platinum pot furnace again to carry out main melting at about 1,450° C. It was then flown into a graphite die to mold, was put into an annealing furnace to anneal and was then taken out as mother glass.

Next, the precipitation step of heating the mother glass was carried out under the condition of generating nucleus for three hours at 610° C. and then growing the particles for four hours at 740° C.

The average grain size of the precipitated halogenated silver particles was 70 nm. When a part of the glass was formed so as to have a thickness of 2 mm to measure the haze, it was about 11%.

Then, the heat-treated mother glass was formed into an experimental preform of 70×250×2 mm (width×length×thickness) to carry out the elongation step.

In the elongation step, the preform was heated so that the viscosity of the glass becomes about 1×10¹⁰ to 1×10¹¹ poise and was elongated while applying stress of about 410 kg/cm² by setting the preform feeding speed at 1.5 mm/min. and the elongated sheet pulling speed at 40 mm/min. to form the elongated sheet.

Then, the polarizing glass was manufactured by annealing the elongated sheet for two hours at 480° C. and then by putting it into hydrogen gas atmosphere under the atmospheric pressure to carry out the reduction step of six hours at 470° C. When the extinction ratio of the polarizing glass was measured after the reduction, it was 65 dB and a bandwidth presenting the extinction ratio of 60 dB or more was about 330 nm.

### Second Embodiment

The same mother glass with that of the first embodiment was prepared and the precipitation step of heat-treating the mother glass was carried out under the condition of growing particles for six hours at 750° C. after generating nuclei for three hours at 610° C. The average grain size of the precipitated halogenated silver particles was 120 nm. When a part of the glass was formed so as to have a thickness of 2 mm to measure the haze, it was about 33%. Then, the heat-treated mother glass was formed into an experimental preform of 70×250×2 mm (width×length×thickness) to carry out the elongation step.

In this elongation step, the preform was heated so that the viscosity of the glass becomes about 1×10¹⁰ to 1×10¹¹ poise and was elongated while applying stress of about 260 kg/cm² by setting the preform feeding speed at 1.5 mm/min. and the elongated sheet pulling speed at 40 mm/min. to form the elongated sheet.

Then, the polarizing glass was manufactured by annealing the elongated sheet for two hours at 480° C. and then by putting it into hydrogen gas atmosphere under the atmospheric pressure to carry out the reduction step of six hours at 470° C. When the extinction ratio of the polarizing glass was measured after the reduction, it was 54 dB and there was no bandwidth presenting the extinction ratio of 60 dB or more.

### Third Embodiment

The same heat treatment with that of the first embodiment was implemented on the same mother glass with that of the first embodiment to prepare an experimental preform having the same shape with that of the first embodiment.

In the elongation step, the preform was heated so that the viscosity of the glass becomes about 1×10¹⁰ to 1×10¹¹ poise and was elongated while applying stress of about 410 kg/cm² by setting the preform feeding speed at 2.5 mm/min. and the elongated sheet pulling speed at 35 mm/min. to form the elongated sheet.

Then, the polarizing glass was manufactured by annealing the elongated sheet for two hours at 480° C. and then by putting it into hydrogen gas atmosphere under the atmospheric pressure to carry out the reduction step of six hours at 470° C. When the extinction ratio of the polarizing glass was measured after the reduction, it was 62 dB and a bandwidth presenting the extinction ratio of 60 dB or more was about 200 nm.

### Fourth Embodiment

Material of glass containing Li₂O by 1.8 w %, Na₂O by 5.5 wt %, K₂O by 5.7 wt %, B₂O₃ by 18.2 wt %, Al₂O₃ by 6.2 wt %, SiO₂ by 56.3 wt %, Ag by 0.22 wt %, Cl by 0.15 wt %, Br by 0.15 wt %, CuO by 0.01 wt %, ZrO₂ by 5.0 wt % and TiO₂ by 2.3 wt % was put into the platinum pot furnace to carry out pre-melting at about 1,350° C. The glass obtained by the pre-melting was crashed into the size of candy as cullets which were then put into the platinum pot furnace again to carry out main melting at about 1,450° C. It was then flown into the graphite die to mold, was put into the annealing furnace to anneal and was then taken out as mother glass.

Next, the precipitation step of heating the mother glass was carried out under the condition of generating nuclei for three hours at 610° C. and then growing the particles for four hours at 735° C.

The average grain size of the precipitated halogenated silver particles was 60 nm. When a part of the glass was formed so as to have a thickness of 2 mm to measure the haze, it was about 9%.

Then, the heat-treated mother glass was formed into an experimental preform of 70×250×2 mm (width×length×thickness) to carry out the elongation step.

In the elongation step, the preform was heated so that the viscosity of the glass becomes about 1×10¹⁰ to 1×10¹¹ poise and was elongated while applying stress of about 410 kg/cm² by setting the preform feeding speed at 1.5 mm/min. and the elongated sheet pulling speed at 40 mm/min. to form the elongated sheet.

Then, the polarizing glass was manufactured by annealing the elongated sheet for two hours at 480° C. and then by putting it into hydrogen gas atmosphere under the atmospheric pressure to carry out the reduction step of six hours at 470° C. When the extinction ratio of the polarizing glass was measured after the reduction, it was 65 dB and a bandwidth presenting the extinction ratio of 60 dB or more was about 110 nm.

### Fifth Embodiment

The same heat treatment with that of the first embodiment was implemented on the mother glass of the first embodiment. In forming the experimental preform from the heat-treated glass, an outer periphery of the preform was ground to adjust its shape, its corners were chamfered by grinding and its front and back surfaces were lapped by #1000. Thus the experimental preform of 70×250×2 mm (width×length×thickness) was formed. Here, although the coarseness of the front and back surfaces of the preform is 200 to 550 Å (from 0.02 to 0.55 μm) when polished, the coarseness of the surface is about 1.5 μm when lapped by #1000. However, the cost of the surface treatment by lapping by #1000 is lower than that by polishing.

In the elongation step, when the preform was heated so that the viscosity of the glass becomes about 1×10¹⁰ to 1×10¹¹ poise and was elongated while applying stress of about 450 kg/cm² by setting the preform feeding speed at 1.5 mm/min. and the elongated sheet pulling speed at 40 mm/min., the preform did not rupture and the elongated sheet did not crack.

### Sixth Embodiment

The same heat treatment with that of the first embodiment was implemented on the mother glass of the first embodiment. In forming the experimental preform from the heat-treated glass, an outer periphery of the preform was ground to adjust its shape, its corners were chamfered by grinding and its front and back surfaces were lapped by #500. Thus the experimental preform of 70×250×2 mm (width×length×thickness) was formed. Here, the surface coarseness of the front and back surfaces of the preform was 2 to 3 μm. The cost of the surface treatment by grinding by #500 is even lower than the surface treatment by #1000.

### Seventh Embodiment

The same mother glass with that of the fourth embodiment was prepared and the precipitation step of heat-treating the mother glass was carried out under the condition of growing particles for four hours at 720° C. after generating nuclei for three hours at 620° C. The average grain size of the precipitated halogenated silver particles was 51 nm. When a part of the glass was formed so as to have a thickness of 2 mm to measure the haze, it was about 7%. Then, the heat-treated mother glass was formed into the experimental preform of 70×250×2 mm (width×length×thickness) to carry out the elongation step.

In the elongation step, the preform was heated so that the viscosity of the glass becomes about 1×10¹⁰ to 1×10¹¹ poise and was elongated while applying stress of about 500 kg/cm² by setting the preform feeding speed at 1.5 mm/min. and the elongated sheet pulling speed at 60 mm/min. to form the elongated sheet.

Then, the polarizing glass was manufactured by annealing the elongated sheet for two hours at 480° C. and then by putting it into hydrogen gas atmosphere under the atmospheric pressure to carry out the reduction step of 6.5 hours at 470° C. When the extinction ratio of the polarizing glass was measured after the reduction, it was 72 dB and a bandwidth presenting the extinction ratio of 70 dB or more was about 110 nm. In this case, a bandwidth presenting the extinction ratio of 60 dB or more was about 230 nm.

### Eighth Embodiment

The experimental preform of 7% of haze fabricated in the seventh embodiment was heated so that the viscosity of the glass becomes about 1×10¹⁰ to 1×10¹¹ poise and was elongated while applying stress of about 680 kg/cm² by setting the preform feeding speed at 1.5 mm/min. and the elongated sheet pulling speed at 60 mm/min. to form the elongated sheet.

Then, the elongated sheet was annealed for two hours at 480° C. and was then put into hydrogen gas atmosphere under the atmospheric pressure to carry out the reduction step of 6.5 hours at 470° C. to manufacture the polarizing glass.

When the extinction ratio of the polarizing glass was measured after the reduction, it was 75 dB and a bandwidth presenting the extinction ratio of 70 dB or more was about 280 nm. In this case, a bandwidth presenting the extinction ratio of 60 dB or more was about 440 nm.

Although the invention has been described by way of the exemplary embodiments, it should be understood that those skilled in the art might make many changes and substitutions without departing from the spirit and scope of the invention.

It is obvious from the definition of the appended claims that the embodiments with such modifications also belong to the scope of the invention.

1. A manufacturing method of polarizing glass containing elongated metal particles dispersed and oriented within glass, comprising:
a melting step of melting mother glass containing metal and halogen;
a precipitation step of precipitating halogenated metal particles by heat-treating said mother glass;
an elongation step of forming said mother glass after heat-treatment into a preform, of heating said preform at such temperature that the viscosity of the glass becomes about 1×10⁸ to 1×10¹⁴ poise, of applying stress of about 200 kg/cm² to 700 kg/cm² to said preform while moving said preform within an electric furnace with feeding speed of 10 mm/min. or less and of elongating said preform as an elongated sheet with pulling speed of 150 mm/min. or less by which an aspect ratio of said halogenated metal particles contained in said preform becomes from 2 to 1 to 100 to 1; and
a reduction step of reducing said elongated sheet for enough time for transforming at least a part of said halogenated metal particles into metal particles at temperature higher than the strain point temperature of said mother glass and lower than the transition point temperature of said mother glass.

2. The manufacturing method of polarizing glass as set forth in claim 1, wherein said precipitation step includes a heat-treatment process for heating said mother glass to generate crystal nuclei for at least one hour at temperature higher than the transition point temperature and lower than the softening point temperature and then to grow said crystal nuclei for at least two hours at temperature higher than the softening point temperature and not higher than the softening point temperature by 70° C. to precipitate halogenated metal particles.

3. The manufacturing method of polarizing glass as set forth in claim 2, wherein a haze (cloudiness) caused by the precipitation of crystal of the precipitated halogenated metal particles is set at 2% to 30% in said precipitation step.

4. The manufacturing method of polarizing glass as set forth in claim 1, wherein the ratio of speed for feeding said preform to speed for pulling said elongated sheet is 15 or more in said elongation step.

5. The manufacturing method of polarizing glass as set forth in claim 1, wherein the stress applied to said preform is 350 kg/cm² or more in said elongation step.

6. The manufacturing method of polarizing glass as set forth in claim 1, wherein the front and back surfaces of said preform and both ends thereof in the longitudinal direction are heated in said elongation step.

7. The manufacturing method of polarizing glass as set forth in claim 1, wherein the composition of the mother glass is, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O:B₂O₃ is about 0.55 to 0.85 and the weight ratio of Ag:(Cl+Br) is about 0.40 to 0.95.

8. The manufacturing method of polarizing glass as set forth in claim 7, wherein the mother glass contains, as the other components, less than 10% of composition selected from components including ZrO₂ by 6% or less, TiO₂ by 3% or less, PbO by 0.5% or less, BaO by 7% or less, CaO by 4% or less, MgO by 3% or less, Nb₂O₅ by 6% or less, La₂O₃ by 4% or less and F by 2% or less.

9. The manufacturing method of polarizing glass as set forth in claim 7, wherein the weight ratio of Ag:(Cl+Br) is 0.60 or less.

10.-11. (canceled)

12. The manufacturing method of polarizing glass as set forth in claim 2, wherein the composition of the mother glass is, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O:B₂O₃ is about 0.55 to 0.85 and the weight ratio of Ag:(Cl+Br) is about 0.40 to 0.95.

13. The manufacturing method of polarizing glass as set forth in claim 3, wherein the composition of the mother glass is, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O: B₂O₃ is about 0.55 to 0.85 and the weight ratio of Ag:(Cl+Br) is about 0.40 to 0.95.

14. The manufacturing method of polarizing glass as set forth in claim 4, wherein the composition of the mother glass is, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O:B₂O₃ is about 0.55 to 0.85 and the weight ratio of Ag:(Cl+Br) is about 0.40 to 0.95.

15. The manufacturing method of polarizing glass as set forth in claim 5, wherein the composition of the mother glass is, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O:B₂O₃ is about 0.55 to 0.85 and the weight ratio of Ag:(Cl+Br) is about 0.40 to 0.95.

16. The manufacturing method of polarizing glass as set forth in claim 6, wherein the composition of the mother glass is, in terms of weight %, Li₂O by 0 to 2.5%, Na₂O by 0 to 9%, K₂O by 0 to 17%, Cs₂O by 0 to 6%, R₂O (Li₂O+Na₂O+K₂O+Cs₂O) by 8 to 20%, B₂O₃ by 14 to 23%, Al₂O₃ by 5 to 25%, P₂O₅ by 0 to 25%, SiO₂ by 20 to 65%, CuO by 0.004 to 0.02%, Ag by 0.15 to 0.3%, Cl by 0.1 to 0.25% and Br by 0.1 to 0.2%, and when no bivalent metal oxide other than CuO is substantially contained within the composition, the mol ratio of R₂O:B₂O₃ is about 0.55 to 0.85 and the weight ratio of Ag:(Cl+Br) is about 0.40 to 0.95.

17.-21. (canceled)
